(19) United States
(12) Patent Application Publication
(10) Pub. No.: US 2010/0122991 A1
(43) Pub. Date: May 20, 2010

(54) SEALABLE CAP FOR SPOUT

(75) Inventors: Akihiro Taguchi, Tokyo-to (JP); Tadahiro Kojima, Tokyo-to (JP); Toshio Mitsuma, Tokyo-to (JP); Akira Sakabe, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: The Coca-Cola Company

(21) Appl. No.: 12/272,223

(22) Filed: Nov. 17, 2008

(51) Int. Cl. B67D 1/00

(52) U.S. Cl. 222/83

(57) ABSTRACT

A device for closing a spout of a flexible container is provided. The device includes a connection tube and a sealable cap having an outer casing member with a lower, outer circumferential surface, an attachment member annularly positioned on a portion of the lower, outer circumferential surface, and an inner casing member having an inner casing sidewall and a bottom disc-shaped occlusion plate defining a cylindrical void space configured to receive a connection tube. The plate can be integrally connected to the inner casing sidewall via a thin-wall section sized to break by the insertion of an insertion edge of the connection tube. The device can also include an overcap sized to mate to the sealable cap.

### TECHNICAL FIELD

Disclosed herein is a sealable cap capable of closing a spout mounted on a flexible container for holding liquids such as beverages. The sealable cap allows the container to be partially opened by a connection tube for extracting the liquids therein.

### BACKGROUND

Beverages have often been stored in flexible containers for shipment to wholesale or retail sellers or consumers. The flexible containers may be bags lined with a synthetic resin film fitted with a spout for dispensing the beverages therein. Typically, a spout has an opening to dispense the beverage, yet the spout is not self-sealing. To ship the flexible container, the opening of the spout is covered by a separate closure, for instance, a sealing cap. The sealing cap can include one or more sections configured to partially open to dispense the beverage from the container.

For example, an aperture section may include multiple layers. The interior layer could be a laminated film having a metal layer facing the interior of the container, and the exterior layer could be a flap configured to open by, for example, peeling the flap away from the container. To access the beverage contained within the flexible container, the flap is peeled away, revealing the laminated film. A dedicated extraction tool could be fitted thereto to break the laminated film, thereby opening the aperture, after which the beverage is extracted using the dedicated extraction tool.

Incidentally, a plurality of steps are required to seal the spout of a flexible container with an aperture section. For instance, a sealable cap having an aperture is produced, a laminated film made of a different material than the cap is attached to the aperture in the sealable cap, and the laminated film layer of the sealable cap is affixed to the spout of the flexible container, thereby sealing it. Due to the number of steps, production costs are relatively expensive.

The conventional sealable cap sealed by a film applied to a small-diameter aperture is currently in use. But a need remains to provide a sealable cap capable of closing a large-diameter spout, for example, about 30 mm, that is formed inexpensively from synthetic resin with a structure, without using separate materials, fitting a small-diameter extraction tool, for example, about 10 mm, thereto.

### SUMMARY

Disclosed herein is a device for closing a spout of a flexible container. In an aspect, the device includes at least a sealable cap and a connection tube. The sealable cap can include an outer casing member having a lower, outer circumferential surface, an attachment member annularly positioned on a portion of the lower, outer circumferential surface, an inner casing member having an inner casing sidewall, and a bottom disc-shaped occlusion plate defining a cylindrical void space configured to receive the connection tube. The plate can be integrally connected to the inner casing sidewall via a thin-wall section sized to break by the insertion of an insertion edge of the connection tube. In addition, the outer casing member, the attachment member, and the inner casing member can be integrated. The connection tube can have an insertion edge, at least a portion of which may be a blade tip.

### BRIEF DESCRIPTION OF THE DRAWINGS

FIG. 1 is a perspective view of an embodiment of a sealable cap and a spout to which the cap attaches;

FIG. 2 depicts a cross-sectional view of the sealable cap of FIG. 1;

FIG. 3 depicts an embodiment of a connection tube for extracting contents inserted in the sealable cap for extracting contents in an inner casing member; and

FIG. 4 is a cross-sectional view of the connection tube opening the bottom of the inner casing member.

### DETAILED DESCRIPTION

Reference will now be made in detail to various, exemplary embodiments, examples of which are illustrated in the accompanying drawings. Wherever possible, the same reference numbers will be used throughout the drawings to refer to the same or like parts.

Disclosed herein is a sealable cap for closing a spout mounted on a flexible container. Depending on the location at which the sealable cap is positioned on the spout, the cap may be removed or may be a mounted permanently or temporarily on the spout.

As one exemplary embodiment, the cap includes an outer casing member, an attachment member, and an outer circumferential wall positioned to define a space to receive the spout. The outer casing member can be inserted in the spout such that the lower outer circumferential surface of the outer casing member is brought into watertight contact with the inner circumferential surface of the spout.

An attachment member positioned on the outer circumference of the outer casing member affixes the outer casing member to the spout by covering the upper spout edge, and an inner casing member that is sunk downward in cylindrical shape in the center of a ceiling surface member that is positioned on the upper edge side of the outer casing member. The ceiling surface member is configured to allow insertion of a connection tube for extracting contents therein, the connection tube having an insertion edge with a blade tip. The outer casing member, attachment member, ceiling surface member, and inner casing member can be integrated. For instance, the outer casing member, attachment member, ceiling surface member and inner casing member can be integrally molded. In another embodiment, any combination of members can be integrally molded. The bottom of the inner casing member can be sealed by a disc-shaped occlusion plate integrally connected via a thin-wall section that can be broken by the insertion edge of the connection tube.

In one embodiment, the thin-wall section has a narrow circular shape. Diameters of the narrow circular shapes may range, for example and without limitation, from about 0.2 mm to about 0.6 mm, from about 0.2 mm to about 0.4 mm, from about 0.4 mm to about 0.6 mm, or from about 0.3 mm to about 0.5 mm.

In another embodiment, the cross-sectional shape of the thin-wall section approximates an ellipse. Major diameters, or major axes, of the elliptical shape may range, for example and without limitation, from about 0.2 mm to about 0.6 mm, from about 0.2 mm to about 0.4 mm, from about 0.4 mm to about 0.6 mm, or from about 0.3 mm to about 0.5 mm.

In another aspect, the thickness of the thin-wall section may be up to 0.35 mm, for example, about 0.25 mm, about 0.30 mm, or about 0.35 mm.

The diameter of the insertion edge of the connection tube approximates the diameter of the thin-wall section. In addition, a downward-pointing V groove in profile is formed at the thin-wall section bounded by at least a portion of the inner circumferential surface of the inner casing member and the outer circumferential surface of the disc-shaped occlusion plate. The angled surface on the inside of the V groove and the angled surface on the inside of the insertion edge of the connection tube can have substantially the same angle.

The materials from which the sealable cap 1 can be constructed include synthetic resins. Exemplary synthetic resins include, without limitation, polyethylene resin such as high density polyethylene, low density polyethylene, linear low density polyethylene, and polyethylene terephthalate. The sealable cap may be constructed from the same or different material as the spout.

In one aspect, a section is derived that allows insertion of the connection tube in the inner casing member independently of the diameter of the outer casing member. The sealable cap has a thin-wall section that can be broken by insertion of the connection tube and can be obtained by molding of synthetic resin in a single manufacturing operation without using separate materials than the other components of the sealable cap.

In another aspect, at least a portion of the thin-wall section is broken by the insertion edge of the connection tube such that the insertion edge strikes the thin-wall section. The disc-shaped occlusion plate can be reliably removed by breakage of the thin-wall section.

In yet another aspect, the insertion edge is guided to the thin-wall section along the angled surface on the inside of the V groove even if the insertion edge of the connection tube should shift relative to the position of the thin-wall section. The insertion edge faces the thin-wall section, and disc-shaped occlusion plate can be removed through breakage of the thin-wall section by the insertion edge.

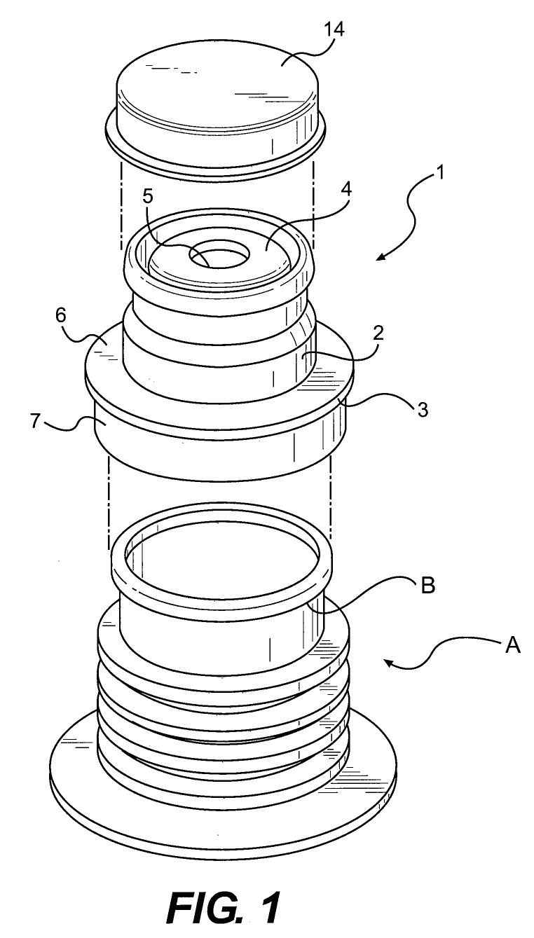

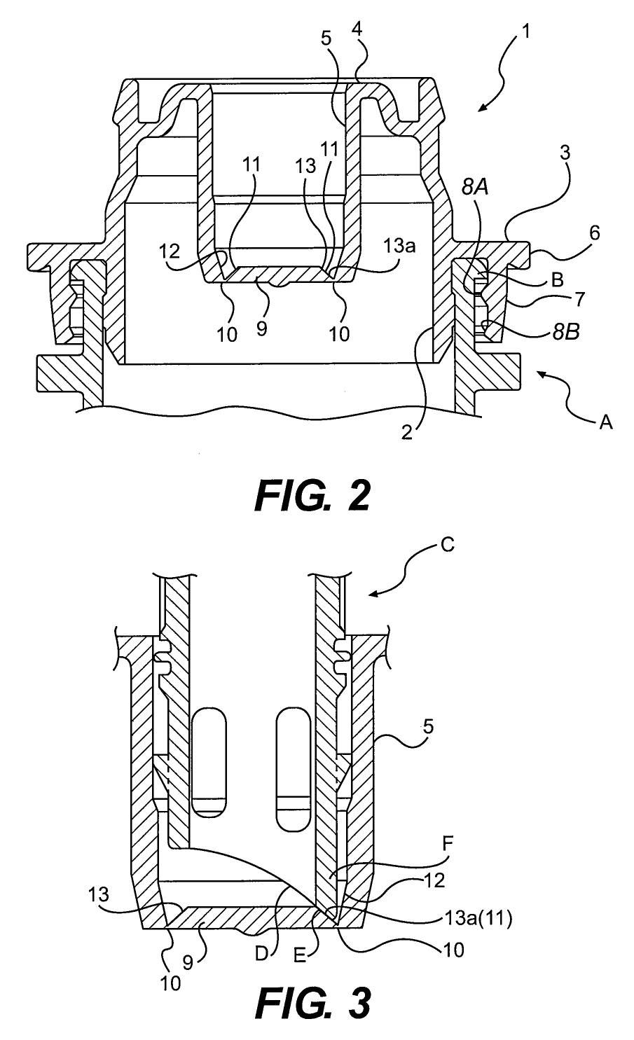

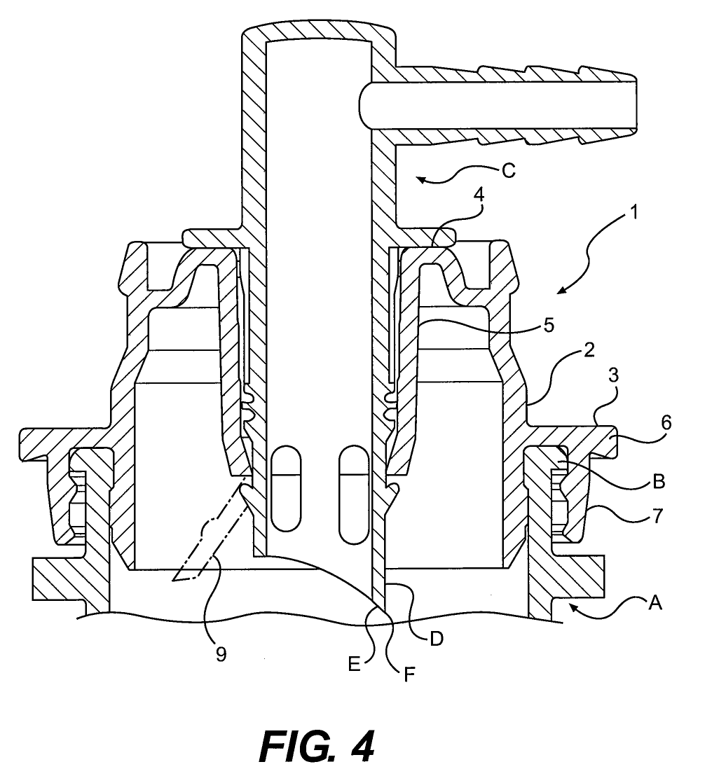

Turning now to FIGS. 1 and 2, an embodiment of a sealable cap 1 capable of closing a spout A is depicted. Sealable cap 1 is configured to contact spout A. In one embodiment, sealable cap 1 is slidingly mounted onto spout A. In another embodiment, sealable cap 1 snaps onto an interior surface of spout A. In yet another embodiment, sealable cap 1 screws onto the interior edge of spout A.

As shown in FIG. 1, sealable cap 1 includes an outer casing member 2. Outer casing member 2 has an outer circumferential surface and is configured to contact spout A. In an embodiment, the outer circumferential surface can be in watertight contact with an inner circumferential surface of spout A.

An attachment member 3 extends laterally outward from outer casing member 2 at a position disposed between the top edge and bottom edge of outer casing member 2. Attachment member 3 can be annularly located about outer casing member 2. A flange 6 extends laterally from attachment member 3 providing a bottom surface from which an outer circumferential wall 7 extends. The diameter of outer circumferential wall 7 is larger than the diameter of outer casing material 2, thereby created a void space.

The void space created by outer casing member 2, attachment member 3 and outer circumferential wall 7 is configured to receive an upper edge of spout A.

The inner surface of outer circumferential wall 7, that is, the surface facing outer casing member 2, includes an upper step 8A and lower step 8B. Upper step 8A and lower step 8B protrude into the void space and resiliently deform when the upper edge of spout 1 passes upper step 8A and/or lower step 8B. When the upper edge of spout A is positioned superior to upper step 8A, upper step 8A prevents spout A from being removed from cap 1. If spout A is moved away from flange 6, upper step 8A catches chin section B, a protrusion on the upper edge of spout A. The upper edge of spout A is located proximal to attachment member 3 and outer casing material 2 such that cap 1 connects to spout A.

Lower step 8B allows spout A to be removed from cap 1. For instance, before the flexible container is filled with beverage, cap 1 may be positioned on spout A to prevent the entry of foreign materials into the empty flexible container. Spout A or cap 1 can be positioned such that the upper edge of spout A is positioned between upper step 8A and lower step 8B. Lower step 8B is configured such that cap 1 is not tightly connected to spout A, thereby facilitating removal of cap 1. Lower step 8B is resiliently deformable as the upper edge of spout A passes lower step 8B in an upward and/or downward direction.

Outer casing member 2 also includes an inner casing member 5 extending at least a portion through cap 1 in the longitudinal direction. Inner casing member 5 defines a void space configured to receive a connection tube C useful for removing the beverage from the flexible container through spout A.

In an embodiment, the diameter of inner casing member 5 tapers from an upper portion to a bottom portion. Inner casing member 5 can taper continuously from the upper portion to the bottom portion. In another embodiment, the diameter of inner casing member 5 tapers in stepwise fashion.

The bottom portion of inner casing member 5 includes a disc-shaped, occlusion plate 9. Occlusion plate 9 is removably integrated with inner casing member 5 via a thin-wall section 10. Thin-wall section 10 can be broken by connection tube 5, thereby providing access to the beverage contained within the container. Thin-wall section 10 is formed by outer circumferential surface 11.

In one exemplary embodiment, the diametric configurations of outer casing member 2 and inner casing member 5 and the thickness of thin-wall section may be selected to facilitate breaking thin-wall section 10. If thin-wall section 10 is too thick in diameter and/or width, thin-wall section 10 may be resistant to breaking. Conversely, if thin-wall section 10 is too narrow in diameter and/or width, it may not retain its shape. In a further aspect, thin-wall section 10 may have a diameter ranging from about 0.2 mm to about 0.6 mm, about 0.2 mm to about 0.4 mm, about 0.4 mm to about 0.6 mm, or from about 0.3 mm to about 0.5 mm. In another aspect, the thickness of thin-wall section 10 may be about 0.25 mm, about 0.30 mm, or about 0.35 mm

Outer circumferential surface 11 can be an inwardly tilting surface. V groove 13 whose cross-sectional shape protrudes downwardly over inner circumferential surface 12 of inner casing member 5 is formed from outer circumferential surface 11 of occlusion plate 9 to thin-wall section 10. Tilted surface 13a on the inside of V groove 13 (specifically, outer circumferential surface 11 of disc-shaped occlusion plate 9) is angled such that its tilting angle approximates the tilting angle of surface E on the inside in pointed section F of insertion edge D of connection tube C.

When connection tube C is inserted in inner casing member 5, pointed section F is guided to outer circumferential surface 11 (or tilted surface 13a) when connection tube C is pushed downward even if pointed section F of insertion edge D should be slightly mispositioned relative to thin-wall section 10, and it would reliably oppose thin-wall section 10.

In another embodiment, an overcap 14 can be sized to mate with cap 1. Overcap 14 can be used before connection tube C is inserted into inner casing member 5, thereby preventing the entry of foreign material into the void space within inner casing member 5.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A device for closing a spout of a flexible container comprising:
a connection tube having an insertion edge, at least a portion of the insertion edge having a blade tip; and
a sealable cap including:
an outer casing member having a lower, outer circumferential surface;
an attachment member annularly positioned on a portion of the lower, outer circumferential surface; and
an inner casing member having an inner casing sidewall and a bottom disc-shaped occlusion plate defining a cylindrical void space configured to receive the connection tube, the plate integrally connected to the inner casing sidewall via a thin-wall section sized to break by the insertion of the insertion edge.

2. The device according to claim 1, wherein the thin-wall section approximates a circular shape and a diameter of the insertion edge approximates a diameter of the thin-wall section.

3. The device according to claim 1, wherein the thin-wall section approximates an elliptical shape and a diameter of the insertion edge approximates a major diameter of the thin-wall section.

4. The device according to claim 1, wherein a void space defined by at least a portion of the inner casing sidewall, the occlusion plate, and the thin-wall section approximates a downward pointing “V” shaped groove.

5. The device according to claim 4, wherein the void space tapers in diameter.

6. The device according to claim 1, further comprising an overcap sized to mate to the cap.

7. The device according to claim 1, wherein the outer casing member, the attachment member, and the inner casing member are integrated.

8. The device according to claim 1, wherein the inner casing member tapers in diameter from an upper portion to a bottom portion.

9. The device according to claim 1, wherein an outer circumferential wall extends in a downward direction from the attachment member.

10. The device according to claim 9, wherein the outer casing member, the attachment member and the outer circumferential wall define a void space configured to receive an upper edge of a spout.

11. The device according to claim 10, wherein the outer circumferential wall comprises at least one step protruding into the void space.

12. The device according to claim 11, wherein the at least one step is resiliently deformable.
